(19) United States
(12) Patent Application Publication
(10) Pub. No.: US 2021/0142690 A1
(43) Pub. Date: May 13, 2021

(54) SYSTEM AND METHOD FOR REPORTING EDUCATIONAL ROBOT PROGRAMMING

(71) Applicant: EVOLLVE, INC., Redondo Beach, CA (US)

(72) Inventors: Mitch Wenger, Manhattan Beach, CA (US); Nader Hamda, Redondo Beach, CA (US); Bon Truong, Torrance, CA (US); Leayle Galiber, Redondo Beach, CA (US); Robert Belt, North Hills, CA (US); Theresa Rapior, Long Beach, CA (US)

(21) Appl. No.: 16/907,077

(22) Filed: Jun. 19, 2020

Related U.S. Application Data
(60) Provisional application No. 62/863,748, filed on Jun. 19, 2019.

(51) Int. Cl. G09B 7/08; G09B 5/14; G06N 3/00

(52) U.S. Cl. CPC G09B 7/08; G06N 3/008; G09B 5/14

(57) ABSTRACT

A learning management system having a teacher terminal. The system obtains, over a wireless computer network and form an educational robot, actual performance data of a lesson performed by a student, where the actual performance data of the lesson includes several instructions that are executed by the educational robot to cause the educational robot to perform a task. The system analyzes the actual performance data according to expected performance data of the lesson. The system determines a proficiency score of the student based on the analyzes of the actual performance data.

### CROSS-REFERENCE TO RELATED APPLICATION

This application claims the benefit of and priority to U.S. Provisional Patent Application Ser. No. 62/863,748, filed Jun. 19, 2019, which is hereby incorporated by this reference in its entirety.

### FIELD

An aspect of the disclosure relates to a learning management system that enables educators to quantitatively assess student proficiency using an educational robot. Other aspects are also described.

### BACKGROUND

A small toy robot (hand held) has been available for some time now that provides not only entertainment value but also can be used as an educational tool for children. The OZOBOT toy robot is a self-propelled, autonomous toy robot that can automatically detect and follow a line segment that appears on a base surface including that of an electronic display screen. The line segment is automatically detected by the robot, and in response the robot moves along the line segment, without requiring any communication with an external device to do so. The toy robot is programmable in that it can be instructed to respond in particular ways to particular color patterns that it detects. A software program editor running on a computing device such as a laptop computer or a tablet computer enables a user to create a block-based program which can then be loaded into memory within the toy robot. For example, if the robot detects a blue segment in the line, it can respond to the blue segment by, for example, moving forward five inches at a fast rate, whereas if it detects a yellow segment it will move forward five inches at a slow rate.

### SUMMARY

The current state-of-the-art of the primary education system (K through 12) in the United States (and other parts of the world) includes many curriculum (or learning) areas. The core grouping of these areas center around five major areas, including Science, Technology, Engineering, Art, and Mathematics (or “STEAM”). The reality, however, of STEAM education is that there is no accurate or efficient way to quantify exactly how well a given student is performing in each (or a subset) of these areas. And as a result, there is no practical way to target an area in which a student is less proficient in order to aid the student's education.

The present disclosure solves this deficiency by providing a learning management system (LMS) that is designed to quantitatively assess a student's proficiency in one or more of these areas by providing lessons that focus on those areas and that use an educational robot. The LMS obtains class progress data (which is based on each student's proficiency) and aggregates class data from one or several schools in order to provide a more global assessment of the schools (or districts that contain the schools). At a more local level, a teacher may use the quantitative assessment to provide individual support (or lessons) that are targeted to each particular student. For instance, a teacher may gear adjust (or provide) individual lessons towards areas that each student is less proficient at. On the other hand, at a more global or macro level, the LMS may provide aggregated data to schools or districts to help determine statistics (e.g., pass/fail rate, etc.) between neighboring schools. These statistics may be used to develop programs and curriculums to better improve a particular school's statistics.

An aspect of the disclosure is a LMS that determines a student's proficiency towards an educational category, such as a learning area or skill using an educational robot. The system obtains, over a wireless computer network and from the educational robot, actual performance data of a lesson performed by a student. For instance, the lesson may ask the student to program the robot to move from one location to another. In this case, the actual performance data of the lesson includes instructions that are executed by the robot to cause the robot to perform the task (e.g., cause the robot to move from point A to point B). The system analyzes the actual performance data according to expected performance data of the lesson and determines a proficiency score of the student based on the analyzing of the actual performance data.

In one aspect, the LMS may automatically categorize a newly uploaded lesson into a lesson library of the LMS. For instance, the LMS obtains the lesson for instructing or programming a robot to perform a task. The lesson may include commands to be followed by the student and/or may include questions to be answered by the student. The lesson may be performed on a student terminal, such as a tablet computer or a writeable surface that can be drawn upon. The LMS automatically (e.g., without user intervention) categorizes the lesson based on at least one of 1) a description of the lesson, 2) commands of the lesson, and 3) questions of the lesson into at least one category. The LMS stores the categorized lesson in the lesson library in order for future educators to use in a classroom setting.

The above summary does not include an exhaustive list of all aspects of the disclosure. It is contemplated that the disclosure includes all systems and methods that can be practiced from all suitable combinations of the various aspects summarized above, as well as those disclosed in the Detailed Description below and particularly pointed out in the claims. Such combinations may have particular advantages not specifically recited in the above summary.

### BRIEF DESCRIPTION OF THE DRAWINGS

The aspects are illustrated by way of example and not by way of limitation in the figures of the accompanying drawings in which like references indicate similar elements. It should be noted that references to “an” or “one” aspect of this disclosure are not necessarily to the same aspect, and they mean at least one. Also, in the interest of conciseness and reducing the total number of figures, a given figure may be used to illustrate the features of more than one aspect, and not all elements in the figure may be required for a given aspect.

FIG. 1 shows a diagram of a learning management system (LMS) that assesses student proficiency according to the student's performance of a lesson that uses an educational robot.

FIG. 2 shows a diagram of another LMS that assesses the skills of a student according to the student's performance of a lesson that is performed on a writeable surface and uses an educational robot.

FIGS. 3A-3C show diagrams of different instruction modes of the LMS, according to one aspect of the disclosure.

FIG. 4 illustrates a graphical user interface (“GUI”) of an application for quantitatively assessing skills of a student.

FIG. 5 illustrates a student report page.

FIG. 6 illustrates a teacher dashboard.

FIG. 7 is a flowchart of one aspect of a process to automatically categorize a lesson.

FIG. 8 is a block diagram of electronic components of an educational robot that can have a changeable skin or outer cover.

### DETAILED DESCRIPTION

Several aspects of the disclosure with reference to the appended drawings are now explained. Whenever the shapes, relative positions and other aspects of the parts described in a given aspect are not explicitly defined, the scope of the disclosure here is not limited only to the parts shown, which are meant merely for the purpose of illustration. Also, while numerous details are set forth, it is understood that some aspects may be practiced without these details. In other instances, well-known circuits, structures, and techniques have not been shown in detail so as not to obscure the understanding of this description.

FIG. 1 shows a diagram of a learning management system (LMS) 1 that assess student proficiency according to the student's performance of a (class) lesson that uses an educational robot. The LMS 1 includes a remote server 2, a teacher terminal 3, at least one student terminal 4, and at least one educational robot 5. In one aspect, the LMS may include any number of terminals and/or educational robots, as described herein. The server 2 may be a real electronic server (e.g., having one or more processors), a virtual machine, or a machine running in a cloud infrastructure). The server 2 may include a network interface that may allow the other devices to access and communicate with the server 2 over a (e.g., wireless) computer network, such as the Internet. As described herein, the server 2 (or memory of the server) may include a server program (or LMS program) that configures the (e.g., processor(s) of the) server 2 to manage a LMS lesson library and exchange data (e.g., class progress data, school data, school district data, etc.) between educators, such as teachers and school officials (e.g., principals, etc.). More about the operations performed by the server 2 is described herein.

The teacher terminal 3 is illustrated as a laptop, but may be any electronic device that is capable of performing network operations to communication with another electronic device and/or capable of executing a teacher program, which when executed by at least one processor of the teacher terminal 3, causes the terminal to present a (teacher) graphical user interface (“GUI”) on a display screen. The student terminal 4 is illustrated as a tablet computer, but may be any electronic device that is capable of performing network operations and/or executing a student program, which when executed by at least one processor of the student terminal 3, causes the terminal to present a (student) GUI on a display screen. In one aspect, the terminals 3 and 4 may be the same (or different) type of electronic device (e.g., both devices may be tablet computers).

In one aspect, the student GUI presented on the student terminal 4 may be different (e.g., provide different data and have different capabilities) than the teacher GUI on the teacher terminal. For instance, as described herein, the teacher program may provide proficiency data associated with students within the class by presenting the data within the teacher GUI. The student program may provide a capability of performing one or more lessons that are assigned by the teacher (terminal).

In one aspect, the teacher terminal 3, the student terminal 4, and/or the educational robot 5 may be configured to establish a communication link over a network (e.g., a Local Area Network (LAN)) with one another and/or other devices. In another aspect, the terminals and educational robot (or at least one of the devices) may be wireless electronic devices that are configured to establish a wireless communication link using any wireless communication method (e.g., using BLUETOOTH protocol or a wireless local network link) with another device in order to exchange data packets (e.g., Internet Protocol (IP) packets). For example, the teacher terminal 3 may be configured to establish a wireless link with the student terminal 4. These terminals may be any type of wireless electronic device, such as a laptop computer, a tablet computer, a portable multimedia device, and a smart phone. In one aspect, any of the devices are configured to establish a wireless communication link with a wireless access point in order to exchange data with the remote server 2 over the Internet.

The educational robot 5 may be any electronic device that is capable of obtaining a set of programming instructions which when executed by at least one processor (or controller) contained therein causes the educational robot to autonomously perform one or more operations in order to complete (or at least partially perform) a task. In one aspect, the processor may control movement using a propulsion sub-system of the robot 5. For instance, the sub-system may include a movement mechanism (e.g., tracks, wheels, etc.), a steering module, and a motor to propel the educational robot in any direction by controlling movement mechanism. In another aspect, the robot may include an actuator (or motor) that may be configured to adjust positions of different elements or portions of the educational robot. As an example, the educational robot 5 may include an adjustable arm, movement of which may be controlled by the processor by transmitting control signals to the actuator. As shown in this figure, the educational robot 5 is an autonomous, self-propelled toy car. In one aspect, the educational robot 5 may be composed of two or more interchangeable components or parts. More about the physical characteristics and capabilities of the educational robot 5 is described in FIG. 8.

As described herein, the LMS 1 is configured to quantitatively assess a student's proficiency in one or more learning areas and/or skills. This process is described as follows. At step 1, the teacher terminal 3 obtains a lesson from (e.g., memory) of the remote server 2. Specifically, a teacher may select a lesson from a group of lessons that are presented within the teacher GUI displayed on the display screen of the terminal 3. Once selected, the terminal (or a network interface of the teacher terminal) may transmit a request, via the computer network (and over the Internet), to the remote server 2 that retrieves the lesson from storage and transmits the lesson back to the teacher terminal 3. In one aspect, the lesson may be retrieved from local storage of the terminal 3. In one aspect, the lesson is a data file that includes content of the lesson (e.g., text, image data, video data, etc.). In another aspect, rather than a data file, the lesson may be a unique identifier (e.g., a URL) from which the lesson may be obtained from a website (e.g., a LMS website).

FIG. 4 illustrates a teacher GUI 40 of the teacher application for obtaining the lesson. The GUI 40 includes a search bar 41 in which a teacher may enter search criteria to find a particular lesson. For instance, the search criteria may be based on the (e.g., scholastic) content, the description, and/or student questions/answers of the lesson. As another example, the search may be based on one or more categories that are associated with a desired lesson. For instance, as described herein, lessons may be categorized based on at least one learning area of which the content of the lesson is associated (e.g., Science, Technology, Engineering, Art, and Math (STEAM), or Science, Technology, Engineering, and Math (STEM)). As an example, when a teacher wishes to obtain a math lesson that includes math questions (e.g., algebra questions), the teacher may add “M” or “Math” as search criteria. In one aspect, the search may be narrowed by including additional criteria, such as “algebra” or information about the questions, such as number of questions, the complexity of the questions, etc. More about the categorization of the lessons is described herein. In one aspect, additional search criteria may be based on statistics, such as how well other students or schools have performed.

In another aspect, search criteria may also include capabilities (or functions) of the educational robot. For instance, as illustrated, the educational robot is a toy car. Thus, search criteria may include terms such as “toy car” in order to obtain a lesson that is associated with the toy car. As another example, when the educational robot 5 includes a moveable arm, such as a crane, the teacher may search and obtain lessons that are associated with moving the crane from one position to another.

In one aspect, there are many types of lessons that may be obtained from the remote server 2. For instance, one type of lesson may include textual instructions (or commands) for a student to instruct or program the educational robot 5 to perform one or more operations in order to complete (or perform) a task. Specifically, an operation may include a movement (e.g., by the robot or by a portion of the robot, such as an arm), an audio processing operation (e.g., using an audio signal to drive an onboard speaker to output sound), an image processing operation (e.g., using a camera to capture image data), and a lighting operation (e.g., an illumination of a lighting element, such as a light emitting diode (LED)). For instance, when the educational robot is a toy car the lesson may instruct a student to program the educational robot 5 to move in a square formation (e.g., “Please program the educational robot to move forward one foot, to make a 90 degree left turn, to repeat these steps three times, and then stop.” In one aspect, the operations that an educational robot may perform are limited by the robot's capabilities (or components). More about the robot's capabilities is described herein.

Another type of lesson may include questions that are associated with at least one category, as described herein. As previously described, such a lesson may be a math lesson that includes one or more math questions. In this case, student performance of the lesson may result in programming the educational robot to perform the task. For instance, criteria may be established in which when a student answers a math question correctly; the robot may be instructed to perform an operation that will bring the educational robot closer to completing the task. In contrast, when a math question is answered incorrectly, the robot may perform a different operation that will not bring the robot closer to completing the task. As an example, right answers may result in the robot moving forward towards a goal line, while a wrong answer may result in the robot remaining still (or not moving). In one aspect, by answering more questions correctly than incorrectly, the educational robot 5 may complete the task more quickly. More about the lessons is described herein.

In one aspect, once a lesson is obtained, the teacher may assign a lesson to one or more students. FIG. 5 illustrates a GUI of a student report page 50 for assigning a lesson to a particular student for display on the teacher terminal 3.

The page includes information regarding this particular student. Specifically, this report shows a proficiency gauge 51 for each of the learning areas of STEAM. In one aspect, the report may include more or less gauges. Each of the gauges includes a proficiency bar 52, where the radial position of the bar (from a 90° position and in a clockwise rotation) indicates how proficient the student is in a particular area. As an example, the bar of the Science gauge is at 135°, illustrating that this student is 37.5% proficient in science, while the Technology gauge is at 225° illustrating that this student is 62.5% proficient in technology. This report also includes assigned lesson progress 53 that indicates the progress of each lesson that is (or was) assigned to this student. In one aspect, the teacher program may include class progress data in a separate GUI. For example, this data may indicate which categories the overall class is proficient at.

The page 50 also includes an assign lesson UI item 54, which when selected by a teacher (e.g., through a mouse click or a tap gesture on a touch sensitive display screen of the teacher terminal), may allow the teacher to assign a lesson to this particular student. In one aspect, once the UI item 54 is selected, the teacher terminal may present one or more lessons (which may include the obtained lesson) for assigning to the student. As a result, a teacher may assign different lessons to different students.

In one aspect, the teacher program may provide a lesson recommendation to the teacher based on past performance data (or past proficiency scores). Specifically, the teacher program may analyze past performance of lessons performed by a particular student and present a recommendation on the student report GUI based on the analysis. In one aspect, the lesson recommendation may be presented (e.g., along with other lessons) when the assign lesson UI item 54 is selected by the teacher. As an example, the program may determine that the last three lessons that are associated with the science category have received a letter grade below a threshold (e.g., B). Thus, the program may present a lesson recommendation of a science lesson on the teacher terminal 3. By recommending lessons based on student proficiency (or lack of proficiency), the teacher may personalize curriculum on a per-student basis.

Returning to FIG. 1, at step 2 the teacher terminal 1 may transmit the obtained lesson to the student terminal 4, via the (wirelessly) network. Once obtained, a student program stored within memory of the student terminal 4 may execute (e.g., by one or more processors) the lesson by presenting (or displaying) at least a portion of the lesson on a display screen of the student terminal. In one aspect, the teacher terminal 3 may wirelessly transmit the lesson (e.g., data file) to the student terminal 4. In another aspect, the teacher terminal may transmit an identifier associated with the lesson, for the student terminal to retrieve the lesson (either from the remote server 2 or from local memory).

At step 3, the student performs the lesson. Specifically, the student terminal 4 obtains a set of instructions to cause the robot to perform (or at least partially perform) the task through user input. For example, as described herein, the lesson may include commands for instructing or programming the educational robot 5 to perform at least one operation in order to complete (or perform) a task, such as causing the educational robot 5 to drive in a square formation. The student may perform the lesson by programming the robot through the student program. Specifically, the student may design and build an executable computer program through user input via a virtual keyboard that is presented on a display screen of the student terminal or through a physical keyboard that is communicatively coupled to the student terminal. Thus, the student may build a program, which when executed by the robot causes the robot to perform one or more operations in order to perform (or complete) a task. In one aspect, any type of programming language (e.g., C++, Java, etc.) may be used to program the robot. As another example, the student may program the robot through a “block-based” programming language, where one or more blocks are presented on the display screen that each represent a particular operation for the educational robot to perform (e.g., one block may be “Turn 90 degrees to the left”, while another block may be “Turn on lighting”) and/or a set of instructions that are to be performed by a programmed processor of the educational robot 5. Thus, to program and design the block-based computer program, the student terminal 3 obtains a user-selection of at least one UI item (e.g., block), where the order of selection dictates the order of which the robot is to perform each operation. When the lesson includes categorized questions (e.g., math questions), the student may enter an answer or select one of several answers that are presented along with the question. In this case, each answer may be associated with an instruction for the educational robot, as described herein. In one aspect, when a question is answered correctly, the correct answer may be associated with one instruction, while an incorrect answer may be associated with a different instruction. In some aspects, instructions associated with correct answers may program the robot to perform a desired task or operation (e.g., based on the lesson), while instructions associated with incorrect answers may program the robot to perform a different task or operation.

In one aspect, the lesson may allow the student to choose which questions the student is to answer and/or which commands the student is to follow. For instance, a lesson may include groups of questions, each group associated with one or more category. As an example, one (e.g., a first) group of questions may be math questions, while another (e.g., a second) group of questions are science (e.g., biology) questions. At the start of the lesson, the student may choose (or select) which group of questions the student is to answer by selecting a UI item on the student terminal. In one aspect, different groups of questions may be associated with different tasks that are to be performed by the educational robot 5. In another aspect, different portions of a particular lesson may be associated with differently categorized (e.g., groups of) questions. For instance, a first portion of the lesson may include math questions, while a later portion includes the biology questions.

At step 4, the student terminal 4 transmits a command message, over the computer network to the educational robot 5 to cause the robot to perform operations (in order to perform or complete a task) according to a set of instructions that are based on (or associated with) the student's performance of the lesson. In one aspect, the student terminal 4 may transmit the command message after the student completes the lesson, or after the student instructs the terminal to do so (based on a selection of a UI item that is presented on the display screen). In another aspect, the student terminal 4 may transmit a command message that includes instructions after each question is answered and/or each command is followed. In another aspect, the command message may include at least a portion of the lesson. Specifically, the command message may include the specific task that is to be performed, the operations to be performed in order to complete the task, etc. The educational robot 5 obtains the command message over the computer network. In one aspect, the educational robot 5 may be continually listening for command messages from the student (and/or teacher) terminal. In another aspect, the educational robot 5 may request the command message, once the educational robot is in an “active-state” or an “on-state” (e.g., turned on). For example, the educational robot may transmit an alert message to the student terminal indicating that the robot is in the active state in order for the student terminal 4 to transmit the command message.

At step 5, the robot performs at least one operation according to the obtained instructions (e.g., moves forward, etc.). Specifically, as described herein, at least one processor of the robot may execute the set of instructions to perform at least one operation. More about how the educational robot performs operations is described herein. In one aspect, the robot 5 may generate (or produce) actual performance data that indicates operations that are being (or to be) performed by the robot (or the instructions that are being or to be executed by the robot). The robot may generate this data while the robot performs each operation (or executes each instruction), or the data may be generated after the robot has completed the set of instructions. In one aspect, the robot may enter a “disconnected state” in which while the robot performs the operations, the robot 5 does not accept transmitted data from any device (e.g., any additional command messages from the student terminal 4). In one aspect, the performance of the operations may result in the robot completing or partially completing the task.

In one aspect, the actual performance data may include the set of instructions that were obtained within the command message. In another aspect, the actual performance data may include data associated with one or more operations that are performed in accordance with the set of instructions. For example the data may include statistics of the operations performed (e.g., the number of operations, the order of operations, etc.). As another example, the actual performance data may include data obtained while performing the operations, such as image data captured by a camera.

At step 6, the educational robot 5 (wirelessly) transmits the actual performance data to the teacher terminal 3. At step 7, the teacher terminal 3 determines a proficiency score for the student based on the actual performance data. The teacher terminal 3 analyzes the actual performance data according to expected performance data of the lesson. The expected performance data may include a predefined set of instructions (or operations), which if executed by the educational robot would perform (and complete) the task associated with the lesson in an expected manner. To determine the proficiency score, the teacher terminal may compare the instructions (or operations) of the actual performance data with the instructions (or operations) of the expected performance data. In one aspect, the comparison may be based on a number of instructions (or operations) performed by the educational robot. For instance, the actual performance data may include a first number of instructions and the expected performance data may include a second number of instructions. The proficiency score may be based on a difference between the first number of instructions and the second number of instructions. The proficiency score may correspond to how much of the task was completed and/or how efficient the educational robot completed (or at least partially completed) the task. In one aspect, the proficiency score may be a percentage value (e.g., 90%) that is present on the student report page of FIG. 5. In another aspect, the proficiency score may be a letter grade that corresponds to a range of values (e.g., 90%-100% is an “A”, etc.). Thus, to determine the letter grade that corresponds to the percentage value.

In one aspect, the student may be associated with one or more proficiency scores for a given lesson. As described herein, a lesson may be categorized by, for example learning areas or skills. Thus, the teacher terminal 3 may determine a proficiency score for each of the categories for a given lesson. For example, in a lesson that includes math and science questions, the student may be assigned a proficiency score for math and a proficiency score for science, based on the performance data. Continuing with this example, the student may obtain a high proficiency score in math, when a task associated with the math questions is completed by the robot (e.g., based on the student answering the math questions correctly) and receive a lower proficiency score in science, when a task associated with the science questions is partially performed by the robot (e.g., based on answering only some or none of the science questions correctly), according to the actual performance data. Thus, the completion of the task may correlate with the number of right answers that the student supplied during performance of the lesson at step 3. These proficiency scores may then be reflected on the student report of FIG. 5.

As described thus far, a student may perform a lesson to cause an educational robot to perform a task. In one aspect, more than one student (e.g., the entire class) may perform a lesson, thereby causing multiple (similar or different) robots to perform a same lesson. As a result, the system may have any number of student terminals, teacher terminals, and educational robots, each at different steps of the process described in FIG. 1. In one aspect, different students may be performing different lessons. In another aspect, different students may perform a lesson with different robots. For example, one student may be instructed to program a toy car (as illustrated in FIG. 1), while another student is instructed to program a toy crane. Thus, two or more educational robots may have a simultaneous wireless connection with the teacher terminal 3, where each educational robot continuously (e.g., in real-time) or periodically transmits actual performance data.

As described herein, the educational robot 5 may transmit the actual performance data after performing one or more operations associated with the set of instructions that are transmitted by the student terminal. In one aspect, the educational robot 5 may transmit actual performance data, while the lesson is in progress (in real-time). Thus, the teacher terminal 3 may analyze the actual performance data (in real-time) and present proficiency scores for each of the students that is participating in the lesson. FIG. 6 illustrates a GUI of a teacher dashboard 70 that may be displayed on the teacher terminal that presents lesson progress data for a given lesson. This dashboard illustrates progress data of a current lesson that is in progress, “Mission to Mars.” Specifically, the dashboard includes lesson progress data 71 that shows metrics for each student who is participating in the current lesson. The data shows proficiency scores (or statuses) for each of the students within the class that are participating within the assigned lesson and an indication of how much of the lesson a student has completed (e.g., Leonie has completed 100% of the lesson). In addition to showing a percentage of how much of the lesson has been completed, the data also shows how many challenges have been completed by each student. In one aspect, a challenge may be associated with at least a portion of a given lesson (e.g., one or more questions and/or one or more sets of instructions). In one aspect, the teacher dashboard may present lesson progress data in real-time (e.g., while the lesson is in progress), and/or it may display data after the lesson has been completed. The teacher may use the dashboard to monitor student performance in real-time in order to determine which students may need help with the lesson. In addition, the dashboard 70 also shows a global class progress bar 72 that illustrates how much of the lesson as a whole has been completed by the class.

One or more educational robots may wirelessly communicate (e.g., using IEEE 802.11x standards) with each other and/or with other devices within the system 1. In one aspect, the educational robot 5 may be configured to communicate over one or more different wireless channels that are in different frequency bands (e.g., a 2.4 GHz, a 5 GHz, etc.). In one aspect, the educational robot may dynamical adjust channel assignment based on a number of educational robots that are operating within the system 1. For instance, the system 1 may spread out channel assignment between the robots in order to reduce interference. In one aspect, the educational robots may communicate their assigned channel with each other. The robots may then adjust channel assignment based on whether there is another robot that is assigned a same (or adjacent) channel.

In one aspect, a student may perform a lesson on a writable surface. FIG. 2 illustrates a learning management system 20 in which the educational robot 5 performs a task according to a set of instructions that are drawn upon a writable surface 21. In one aspect, the writable surface 21 may include any surface (e.g., a piece of paper, etc.) that a user can draw or write on with a writing instrument (e.g., a pencil, a colored marker). In another aspect, the touch-sensitive display screen of the student terminal 4 may be the writable surface. In this case, the student may draw upon a virtual piece of paper that is presented on the display screen by touching the touch-sensitive display screen using a stylist or the user's finger.

The writable surface 21 includes a set of instructions as different lines. Each of the different lines may correspond to a set of instructions or operations that are to be performed by the educational robot. In this example, the surface includes a bold straight line that may be associated with a set of instructions that instruct the robot to move straight, a dashed line that may be associated with a set of instructions that instruct the robot to make a 90° turn to the left and proceed along the path, and a dotted line that may be associated with a set of instructions that instruct the robot to turn left and move in a semi-circular fashion.

The robot 5 obtains the set of instructions from the writeable surface 21 based on sensor input of one or more sensors. For instance, the robot 5 may include a line sensor (e.g., a camera) that is configured to capture image data within the field of view of the sensor. The robot may run an object recognition algorithm upon the image data to detect objects contained therein. Specifically, the algorithm may be configured to detect lines, as illustrated herein. Once detected, the robot may perform a table lookup into a data structure that associates predefined different types of lines with sets of instructions. Once the robot identifies a matching predefined line with a line identified within the image data, the robot may executed the set of instructions associated with the match. While executing the set of instructions, the robot may generate actual performance data and transmit the data in real-time to the teacher terminal. In one aspect, in addition to recognizing lines, the robot may obtain instructions based on recognized characters or text that is written on the writable surface 21. For example, upon recognizing the words “move forward”, the robot may move forward.

In one aspect, the LMS 1 (e.g., the teacher terminal) may aggregate lesson progress data into class progress data that provides an indication of class performance for a given lesson. For instance, the class progress data may include a percentage (e.g., progress 72 illustrated in FIG. 6) or an average letter grade for the lesson plan by averaging grades that are assigned to the students. In another aspect, the class progress data may include average proficiency scores for one or more categories that are associated with the lesson. In one aspect, the class progress data does not include student identification information (e.g., a student's name). Once class progress data is produced, at step 8 the teacher terminal may transmit the data to the remote server that stores the data and associates the data with the lesson. In this way, other educators that wish to obtain the lesson may see how well other classes have performed.

In another aspect, the LMS may determine school data and/or school district data based on the class progress data. School data may include the proficiency of all students (e.g., students within a specific grade or specific class) in one or more categories. The school data also may indicate any trends (e.g., whether there have been improvements) and statistics as to why there have been trends (e.g., the data may indicate what lessons have been assigned during a positive or negative trend). School district data, on the other hand may include comparisons between two or more schools within the district. For example, this data may indicate which school in the district has a higher proficiency in math. In one aspect, it should be understood that this data may include any statistical data that may be derived from the class progress data.

In one aspect, at least some of the operations performed by the LMS 1 may be performed by a web-based application. Specifically, rather than (or in addition to) the teacher terminal storing a teacher program within local memory, the teacher terminal may access LMS content (e.g., the teacher dashboard, the lesson library, etc.) via a web-browser. Similarly, the student terminal may access content of the LMS 1 via a web-browser. Thus, any electronic device with an Internet connection may participate within the LMS 1.

As described herein, the LMS 1 is configured to quantitatively assess a student's proficiency by performing one or more steps of the process described in FIG. 1. To perform this process, the teacher terminal 3, the student terminal 4, and/or educational robot 5 communicate with one another in a peer-to-peer local instruction mode (e.g., a first instruction mode), via a wireless (e.g., BLUETOOTH) protocol. In one aspect, however, the LMS may quantitatively assess one or more students while in one of several instruction modes, including the first mode described herein. FIGS. 3A-3C show diagrams of different instruction modes of the LMS, according to one aspect of the disclosure.

Specifically, FIG. 3A shows an example of the LMS1 operating in an asynchronous remote instruction mode (e.g., a second instruction mode). Specifically, in this mode the teacher terminal 3 communicates with the educational robot 5 and student terminal 4 via the remote server 2, and over a computer network, such as the Internet. The process performed by the LMS while in this mode includes the following steps, some of which are the same or similar to steps described in FIG. 1. In step 1, the teacher terminal obtains a lesson from the remote server. In step 2, the teacher terminal transmits the lesson for a student to the remote server 2, bound for that student's terminal. In step 3, the remote server transmits the lesson to the student terminal, where at step 4 the student performs the lesson. At step 5, the student terminal transmits instructions or a program produced by the student in response to performing the lesson to the educational robot, which performs at least one operation according to the obtained instructions or program. At step 7, the robot transmits actual performance data back to the student terminal. At step 8, the student terminal transmits data of the lesson to the remote server, bound for the teacher terminal. In one aspect, the student terminal may transmit the actual performance data obtained from the educational robot and/or transmit lesson progress data (e.g., information indicating how much of the lesson has been competed, etc.). At step 9, the remote server transmits the data obtained from the student terminal to the teacher terminal, which at step 10 determines the student's proficiency score based on the actual performance data.

In one aspect, the operations described in this second instruction mode may not (or may) be performed in real-time. For instance, the remote server may store the lesson for the student (from the teacher terminal) until the remote server establishes a communication link with the student terminal. As another example, data from the student terminal may be stored in the remote server until the teacher terminal transmits a request to retrieve such data.

As described herein, more than one student may perform a same (or different) lesson, thereby causing multiple robots to perform the lesson. FIG. 3B shows an example of the LMS 1 operating in a multi-asynchronous instruction mode (e.g., third instruction mode), in which multiple students are performing a lesson. As shown, the LMS 1 includes several student terminals 4a-4n and several educational robots 5a-5n, where each robot is associated (or paired) with a student's particular student terminal (e.g., robot 5a is paired with terminal 4a). In this mode, pairs of educational robots and respective student terminals perform individual lessons, as described in FIG. 3A. Thus, in this mode each of the students may perform the lesson (or portions of the lesson) at different times. In one aspect, however, at least some of the students may perform the lesson contemporaneously with one another, such that the teacher terminal receives actual performance data from multiple student terminals at any given time. In some aspects, each of the pairs may be communicatively coupled with the teacher terminal (via the remote server) in a local (e.g., “in-class”) location or a remote location, with respect to the teacher terminal. Thus, lessons may or may not be performed while the student is present with the teacher.

FIG. 3C shows an example of the LMS 1 operating in a synchronous instructions mode (e.g., fourth instruction mode). In this mode, the teacher terminal 3 communicates directly with the educational robots 5a-5n. In one aspect, by communicating directly with the educational robots, latency for the teacher terminal to receive the actual performance data from the robots may be reduced, as opposed to other instruction modes (such as the second mode described herein). The process to quantitatively assess students performed by the LMS 1 while in this mode is described as follows. In step 1, the teacher terminal obtains a lesson, and in step 2 the lesson is transmitted to the remote server 2 to be transmitted to one or more students. At step 3, the remote server transmits the lesson to each individual student terminal (e.g., contemporaneously). In step 4, the student performs the lesson at the student terminal, and in step 5 the student terminal transmits at least one message that includes instructions or program data back to the remote server 2, which in step 6 forwards the message to the teacher terminal. The teacher terminal obtains the message, and in step 7, the teacher terminal transmits the instructions or program data received from each student's student terminal to a respective educational robot (e.g., instructions from student terminal 4a is transmitted to robot 5a), for execution by the robot. In step 8, the robot performs operations by executing the instructions or program data, and in step 9 transmits actual performance data to the teacher terminal. At step 10, the teacher terminal determines each student's proficiency score, as described herein.

In one aspect, the fourth instruction mode may be performed while students are in-class and/or remote. For example, when performing a lesson, the educational robots may be in a same location as the teacher terminal, while on the other hand the students may either be at the same location or in a remote location. Thus, lessons may be performed by students at any location, so long as their respective student terminals have a communication link with the remote server over a computer network.

As described herein, the LMS may manage a lesson library, which may be stored on the remote server 2. In one aspect, the lesson library may be populated with lessons by a third-part provider. In another aspect, the lesson library may be populated by educators, such as teachers. In one aspect, the LMS 1 may automatically categorize a lesson. FIG. 7 is a flowchart of one aspect of a process to automatically categorize a lesson. As described herein, categories may include at least one of the learning areas: science, technology, engineering, art, and/or math (STEAM or STEM). In another aspect, categories may include skills that the lessons are intended to improve for a student. The skills may include creativity, collaboration, communication, and critical thinking (“The Four C's”).

The process 60 begins by obtaining a lesson for instructing or programming a robot to do a task (at block 61). To obtain the lesson, a teacher may upload the lesson (e.g., a data file) into the lesson library. For instance, the teacher may navigate to a web page on the teacher terminal 3 that is for uploading lessons into the lesson library. In another aspect, the teacher program may have a GUI that is configured to obtain lessons. In one aspect, the uploaded lesson may include any data or information that is necessary for 1) the student to perform the lesson and 2) the teacher to determine the student's performance of the lesson. For example, the lesson may include a description (e.g., including text, images, etc.) of the lesson, commands that the student is to follow while performing the lesson, questions that the student is to answer, etc. In addition, the lesson may include data that may only be presented (or made available) on the teacher terminal. For example, the lesson may include the expected performance data (e.g., operations that a robot is to perform), answers to the questions, etc.

The process 60 automatically (without user intervention) categorizes the lesson based on the content of the lesson (at block 62). For instance, the LMS may analyze he description of the data, the commands, the question/answers, and expected performance data to determine which categories are to be associated with the lesson. For example, the LMS may analyze the scholastic content of the questions/answers and determine which of the categories is associated with the content. As an example, when the questions include a math problem (“2+2”), the LMS may identified that the problem includes a plus sign “+”, indicating that the problem is a math problem. Once identified, the lesson may be categorized under “M”. In another aspect, the LMS may categorize components of the lesson. For instance, along with categorizing the lesson under “M”, the LMS may categorize the specific problem as “M”. Thus, the lesson may be categorized under two or more categories, based on the scholastic content of the problems contained therein.

The process 60 stores the categorized lesson in the lesson library (at block 63). Specifically, the LMS may store the lesson in the memory of the remote server 2. In one aspect, the LMS may sore the lesson with other similarly categorized lessons.

In one aspect, a lesson may be categorized based at least partially on user input. Specifically, while uploading the lesson into the lesson library, the teacher may categorize the lesson manually (e.g., through a user selection of UI items displayed on the teacher terminal). For instance, the teacher may categorize the lesson as any of the learning areas and/or skills. As another example, the teacher may categorize specific questions in the lesson and/or commands that are outlined throughout the lesson.

FIG. 8 is a block diagram of electronic components of an educational robot that can have a changeable (or interchangeable) skin or outer cover. Specifically, this figure illustrates a block diagram of hardware components that are within the robot body housing, and hardware components of a skin or outer cover that may be interchangeable with one or more other skins or outer covers. In one aspect, each skin or outer cover may include different capabilities, thereby allowing the robot to perform different (or similar) operations and/or tasks. The housing includes a microphone, a speaker, a line sensor, a propulsion sub-system, a network interface, a memory, a power device (e.g., power source, such as a battery), an actuator/motor, an outer cover interface, and a body-side controller. In one aspect, the housing may include more or less hardware components as described herein, such as having one or more light emitting diode (LED).

The outer cover includes a memory, a speaker, sensors (e.g., a camera, a proximity sensor, a pressure sensor, etc.), an actuator/motor, lighting, a robot body interface, and a skin-side controller. As described herein, the skin or outer cover is configured to be interchangeably coupled with the housing in order to change the capabilities of the robot. As one example, an outer cover may be a shell of a car (as illustrated in FIG. 1), while another outer cover may be a crane that is configured to pick up objects.

In one aspect, when an outer cover is coupled to the housing, the robot may transmit a message (e.g., to the teacher terminal), indicating what capabilities or operations the robot may perform with the attached outer cover. In one aspect, the message may be transmitted after the outer cover is attached, or the message may be transmitted in response to a request from the teacher terminal. When the outer cover is coupled to the housing, the outer cover interface couples to the robot body interface to form a wired communications link and a wired power supply link. The power supply link supplies power enables the power device to supply power to the components of the outer cover, while the wired communication link may allow serial transfer of data between the housing (e.g., body-side controller) and the cover (e.g., skin-side controller). Once power is supplied, the skin-side controller (that may be at least one processor) executes the skin-side program that is stored in memory. The program transmits skin data that is stored in memory that describes the capabilities (e.g., the components of the skin or outer cover) to the body-side controller (which may include at least one processor) in order to wirelessly transmit the data, via the network interface to the teacher terminal.

In one aspect, the body-side program may process instructions obtained by the student terminal in order to perform one or more operations, as described herein. For instance, the body-side program may determine which instructions are associated with operations that are to be performed by the housing or by the outer cover. For instance, a movement operation may be performed by the propulsion sub-system, while a lighting operation may be performed by the lighting of the outer cover. Thus, the body-side program parses the instructions to the skin-side program accordingly, and may manage which operations are performed in what order.

In one aspect of the disclosure, a method includes obtaining a lesson for instructing or programming a robot to do a task, the lesson having at least one of several commands and several questions, where the lesson is to be performed on a student terminal of a student or a writeable surface that can be drawn upon, categorizing, without user intervention, the lesson based on at least one of 1) a description of the lesson, 2) the commands, and 3) the questions into at least one category of several categories, and storing the categorized lesson in a lesson library. In another aspect, the several categories are learning areas including science, technology, engineering, arts, and math (STEAM). In some aspects, each question of the several questions includes scholastic content that is associated with at least one of the learning areas, where the lesson is categorized according to the learning area of the question. In one aspect, each of the questions of the several questions is associated with a portion of the lesson, where categorizing the lesson includes categorizing each portion based on each question that is associated with the respective portion. In one aspect, the several categories are skills including creativity, collaboration, communication, and critical thinking (CCCC).

As previously explained, an aspect of the disclosure may be a non-transitory machine-readable medium (such as microelectronic memory) having stored thereon instructions, which program one or more data processing components (generically referred to here as a “processor”) to perform the network operations and signal processing operations. In other aspects, some of these operations might be performed by specific hardware components that contain hardwired logic. Those operations might alternatively be performed by any combination of programmed data processing components and fixed hardwired circuit components.

While certain aspects have been described and shown in the accompanying drawings, it is to be understood that such aspects are merely illustrative of and not restrictive on the broad disclosure, and that the disclosure is not limited to the specific constructions and arrangements shown and described, since various other modifications may occur to those of ordinary skill in the art. The description is thus to be regarded as illustrative instead of limiting.

In some aspects, this disclosure may include the language, for example, “at least one of [element A] and [element B].” This language may refer to one or more of the elements. For example, “at least one of A and B” may refer to “A,” “B,” or “A and B.” Specifically, “at least one of A and B” may refer to “at least one of A and at least one of B,” or “at least of either A or B.” In some aspects, this disclosure may include the language, for example, “[element A], [element B], and/or [element C].” This language may refer to either of the elements or any combination thereof. For instance, “A, B, and/or C” may refer to “A,” “B,” “C,” “A and B,” “A and C,” “B and C,” or “A, B, and C.”

What is claimed is:

1. A method performed by a learning management system having a teacher terminal, the method comprising:
obtaining, over a wireless computer network and from an educational robot, actual performance data of a lesson performed by a student, wherein the actual performance data of the lesson includes a plurality of instructions that are executed by the robot to cause the robot to perform a task;
analyzing the actual performance data according to expected performance data of the lesson; and
determining a proficiency score of the student based on the analyzing of the actual performance data.

2. The method of claim 1, wherein the plurality of instructions has a first number of instructions, wherein the expected performance data of the lesson has a second number of instructions that when executed by the robot causes the robot to perform the task in an expected manner, wherein analyzing the actual performance data comprises determining a difference between the first number of instructions and the second number of instructions.

3. The method of claim 2, wherein the difference is a percentage value, wherein determining the proficiency score comprises determining a letter grade that corresponds to the percentage value.

4. The method of claim 1, wherein the lesson comprises a plurality of questions that are each associated with a category of a plurality of categories.

5. The method of claim 4, wherein the plurality of categories comprise science, technology, engineering, arts, and math (STEAM).

6. The method of claim 5, wherein each of the set of instructions is associated with the student's answer for a corresponding question of the plurality of questions, wherein analyzing the actual performance data according to the expected performance data comprises determining, for each of the plurality of questions, the student's answer to the question based on the set of instructions.

7. The method of claim 6, wherein determining the proficiency score comprises determining a proficiency score for at least one of the categories based on the student's answers to questions that are associated with that category.

8. The method of claim 7, wherein the teacher terminal obtains actual performance data of the lesson performed by a plurality of students, wherein the method further comprises
averaging, for each category, proficiency scores of the plurality of students to produce class progress data; and
transmitting the class progress data to a remote server that stores the data and associates the data with the lesson.

9. The method of claim 1 further comprising
obtaining, over the wireless computer network, a message from a student terminal that includes the plurality of instructions; and
transmitting, over the wireless computer network the plurality of instructions for execution by the robot.

10. A method performed by educational software that is executed by a processor of a student terminal of a student, wherein the student terminal is a portable electronic device, the method comprising:
presenting, on a display screen of the student terminal, a lesson for instructing or programming a robot to perform a task;
obtaining a set of instructions to cause the robot to perform the task; and
transmitting, over a wireless computer network, a command message to the robot to cause the robot to perform the task based on the set of instructions.

11. The method of claim 10, wherein the robot performs one or more operations in response to at least one processor of the robot executing the set of instructions, wherein obtaining the set of instructions comprises obtaining user input that indicates the operations that are to be performed by the robot in order to complete the task.

12. The method of claim 11, wherein the user input is one of 1) textual input or 2) a user-selection of a user interface (UI) item that is presented on the display screen and associated with a particular operation.

13. The method of claim 11, wherein the one or more operations comprises a movement of the robot, a movement of a portion of the robot, using an audio signal to drive a speaker to output sound, and an illumination of a lighting element of the robot.

14. The method of claim 10, wherein the lesson comprises 1) a first plurality of questions that are associated with a first category of a plurality of categories and 2) a second plurality of questions that are associated with a second category of the plurality of categories.

15. The method of claim 14, wherein each of the plurality of categories is one of a plurality of learning areas comprising science, technology, engineering, arts, and math (STEAM).

16. The method of claim 15 further comprising obtaining user input to select which of the first plurality of questions and the second plurality of questions are to be answered by the student, wherein obtaining the set of instructions comprises obtaining an answer for each of the selected questions, wherein the answer is associated with an instruction to be performed by the robot.

17. An educational management system comprising:
a robot that is configured to obtain a set of instructions for performing a task, wherein the robot obtains the set of instructions from either 1) a student terminal that is configured to a) present, on a display screen, a lesson for instructing or programming the robot to perform the task, b) obtain the set of instructions as user input based on the lesson, and c) transmit, over a wireless computer network, a message to the robot that has the set of instructions, or 2) a writeable surface that can be drawn upon; and
a teacher terminal that is configured to obtain, over the computer network, actual performance data from the robot that indicates a number of operations performed by the robot in order to complete the task.

18. The system of claim 17, wherein the robot obtains the set of instructions from the writeable surface by capturing, using a camera, image data that represents a field of view of the camera that includes the writeable surface and performing an image recognition algorithm upon the image data to identify a line or text written on the surface, wherein each of the set of instructions is based on either the line or text.

19. The system of claim 17, wherein the robot is further configured to perform the task after obtaining the set of instructions, wherein while performing the task the robot cannot obtain additional messages from the student terminal.

20. The system of claim 17, wherein the robot is further configured to transmit an alert message to the student terminal indicating that the robot is in an on-state, wherein the student terminal transmits the message in response to obtaining the alert message.
